(19) United States
(12) Patent Application Publication
(10) Pub. No.: US 2004/0183365 A1
(43) Pub. Date: Sep. 23, 2004

(54) Vehicle braking device

(76) Inventors: Masahiko Kamiya, Kariya (JP); Hiroshi Kondo, Kariya (JP); Shin Sasaki, Kariya (JP); Daizo Oba, Kariya (JP)

Correspondence Address: BURNS DOANE SWECKER & MATHIS L L P, POST OFFICE BOX 1404, ALEXANDRIA, VA, 22313-1404, US

(21) Appl. No.: 10/781,646

(22) Filed: Feb. 20, 2004

(30) Foreign Application Priority Data
Mar. 20, 2003 (JP) 2003-77147

(51) Int. Cl. B60T 13/16

(52) U.S. Cl. 303/10

(57) ABSTRACT

The aim is to reliably detect abnormality of a brake device with a simple structure without providing a special detecting means. A pump for generating brake hydraulic pressure of a hydraulic brake device is driven when the ignition switch for starting the vehicle is closed. The rise time of the output of a brake hydraulic pressure detecting means provided in the hydraulic brake device is detected, and it is determined that uneven wear of the pads has occurred if the rise time is longer than a predetermined time. An alarm lamp is turned on to notify abnormality. Thereby it is possible to accurately detect abnormality of the brake device before the driver drives the vehicle without providing a special detecting means.

### BACKGROUND OF THE INVENTION

This invention relates to a vehicle braking device having a brake device for pressing pads against a disk rotor, more particularly to a braking device adapted to detect abnormality of the brake device beforehand.

In a vehicle braking device having a hydraulic brake device for pressing pads against a disk rotor with the brake hydraulic pressure of each wheel cylinder, in order to achieve high-level behavior control of the vehicle and light brake operating feeling, an increasing number of automobiles are provided with a pump for generating brake hydraulic pressure by supplying brake fluid to the wheel cylinders, and are adapted to detect the operating force and operating amount of the brake pedal as electric signals to control the driving of the pump based on these electric signals. Among such braking devices which have a pump controlled by electric signals, there are ones in which brake fluid resupply passage for resupplying brake fluid from the master cylinder to the wheel cylinders is provided to resupply brake fluid from the master cylinder to the wheel cylinders during hard braking operation in which supply of brake fluid from a hydraulic pressure generating source is short, by opening a shutoff valve provided in the brake fluid resupply passage. A braking device for controlling this type of hydraulic brake device is usually provided with a brake hydraulic pressure detecting means for detecting brake hydraulic pressure in the wheel cylinder.

Further, among vehicle braking devices, there are ones having a power brake device in which rotary motion of a motor is converted to linear motion of a piston to press pads against the respective disk rotors with the linear motion of the piston to control the driving of the motor according to the operation of the brake pedal. In this kind of braking device, which controls a power brake device, normally, there is provided a pad pressing load detecting means for detecting the pressing load of pads. In order to reinforce braking force by the power brake device, there are hydraulic pressure resupply type ones in which a hydraulic cylinder for pressing pads against each disk rotor is provided to supply brake fluid from the master cylinder to this hydraulic cylinder.

On the other hand, in such a vehicle braking device which has a hydraulic brake device for pressing pads against each disc rotor or a power brake device, due to uneven wear of the pads, gaps between the pads and each disk rotor may increase, or the slide resistance of the wheel cylinders or the piston increases, so that the brakes will not work properly even when the brake pedal is operated.

Among vehicle braking devices having such a power brake device, there are ones in which a position detecting means for detecting the stroke position of the piston is provided to adjust gaps between pads and a disk rotor by driving the abovementioned motor while the vehicle is traveling (e.g. disclosed in JP patent publication 2000-46082 (pages 3-6, FIGS. 1-3)).

In the above method in which the stroke position of the piston is detected to adjust gaps between pads and a disk rotor, it is necessary to mount a position detecting means in a narrow space and convert the output of this position detecting means to gaps between pads and each disk rotor. Thus the device tends to be complicated and expensive. Further, if gaps between pads and each disk rotor increase due to uneven wear of the pads, this method is effective to prevent a delay in the working of the brakes, but is useless if the slide resistance of the wheel cylinders or the piston increases.

An object of this invention is to make it possible to reliably detect abnormality of the brake device with a simple structure without providing a special detecting means.

### SUMMARY OF THE INVENTION

According to this invention, there is provided a vehicle braking device adapted to be started by an ignition switch and comprising a master cylinder coupled to a brake pedal, a wheel cylinder, a hydraulic brake device for pressing pads against a disk rotor under brake hydraulic pressure of the wheel cylinder, a pump for supplying brake fluid from the master cylinder toward the wheel cylinder to generate brake hydraulic pressure in the wheel cylinder, and a brake hydraulic pressure detecting means for detecting the brake hydraulic pressure in the wheel cylinder, wherein the hydraulic brake device is controlled according to the operation of the brake pedal, wherein when the ignition switch is closed, the pump is driven and the rise time of the brake hydraulic pressure is detected by the brake hydraulic pressure detecting means, and further comprising an uneven wear detecting means which determines that uneven wear of the pads has occurred if the rise time of the brake hydraulic pressure is longer than a predetermined time.

That is, by driving the pump for generating brake hydraulic pressure in the wheel cylinder when the ignition switch for starting the vehicle is closed, detecting the rise time of the brake hydraulic pressure, and determining that the brake device is abnormal if the rise time is longer than a predetermined time, it becomes possible to detect abnormality of the brake device (especially uneven wear of pads) with a simple structure without newly providing a special detecting means.

If a brake fluid resupply passage for resupplying brake fluid from the master cylinder to the wheel cylinder is provided, it is preferable that the brake fluid resupply passage is shut off when the ignition switch is closed. This makes it possible to eliminate the influence of the hydraulic pressure from the master cylinder, i.e. the pressure generated by the stepping force of the driver. Thus it is possible to make more accurate judgement.

According to this invention, there is also provided a vehicle braking device for a vehicle started by an ignition switch, comprising a power brake device for converting the rotary motion of a motor to the linear motion of a piston and pressing pads against a disk rotor with the linear motion of the piston, and a pad pressing load detecting means for detecting the pressing load of the pads against the disk rotor by the piston, wherein the power brake device is controlled according to the operation of the brake pedal, wherein when the ignition switch is closed, the motor is driven and the rise time of the pad pressing load is detected by the pad pressing load detecting means, and further comprising an uneven wear detecting means which determines that uneven wear of the pads has occurred if the rise time of the pad pressing load is longer than a predetermined time.

That is, in the vehicle braking device provided with a power brake device, too, by driving the motor for linearly moving the piston when the ignition switch for starting the vehicle is closed, detecting the rise time of the brake hydraulic pressure, and determining that the brake device is abnormal if the rise time is longer than a predetermined time, it is possible to detect abnormality of the brake device (especially uneven wear of pads) with a simple structure without providing a special detecting means.

By providing the alarm generating means for generating an alarm if the uneven wear detecting means determines that uneven wear of the pads has occurred, it is possible to properly notify the driver of abnormality of the brake device, and thus to prompt the driver to earlier inspection or repair.

### BRIEF DESCRIPTION OF THE DRAWINGS

Other features and objects of the present invention will become apparent from the following description made with reference to the accompanying drawings, in which:

FIG. 1 is a system diagram showing the vehicle braking device of a first embodiment;

FIG. 2 is a sectional view showing the hydraulic brake device of FIG. 1;

FIG. 3 is a control flowchart by the controller of FIG. 1 at the start of the vehicle;

FIG. 4 is a graph explaining the output of a pressure sensor used in the control of FIG. 3;

FIG. 5 is a system diagram showing the vehicle braking device of a second embodiment; and

FIG. 6 is a control flowchart by the controller of FIG. 5 at the start of the vehicle.

### DETAILED DESCRIPTION OF THE PREFERRED EMBODIMENT

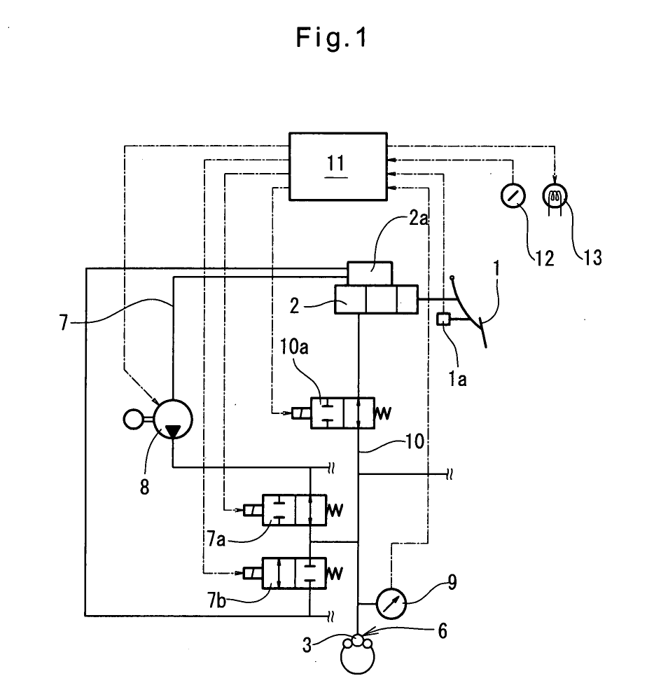

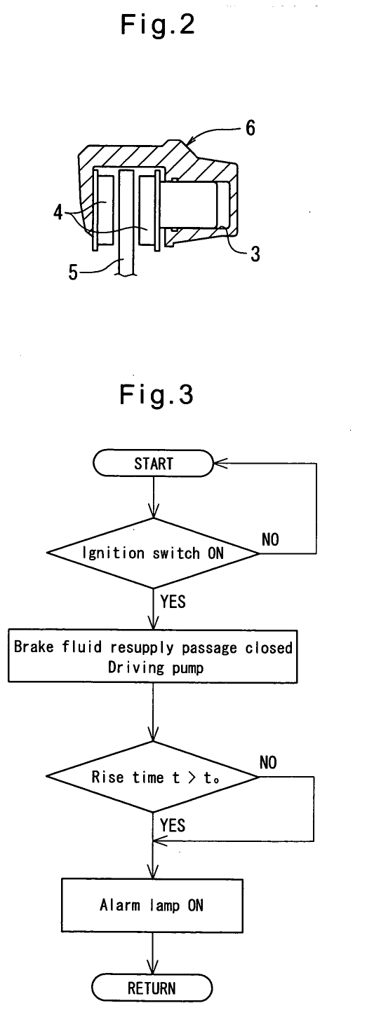

The embodiments of this invention will be described with reference to FIGS. 1-6. FIGS. 1-4 show the first embodiment. This vehicle braking device comprises, as shown in FIGS. 1 and 2, a master cylinder 2 coupled to a brake pedal 1, a hydraulic brake device 6 for pressing pads 4 against a disk rotor 5 under the brake hydraulic pressure of a wheel cylinder 3, a circulating passage 7 having solenoid valves 7a and 7b on the supply side toward the wheel cylinder 3 and on the return side from the wheel cylinder 3, respectively, for circulating brake fluid between a reservoir tank 2a of the master cylinder 2 and the wheel cylinder 3, a motor-driven pump 8 for supplying brake fluid from the master cylinder 2 toward the wheel cylinder 3 to generate brake hydraulic pressure, a pressure sensor for detecting the brake hydraulic pressure in the wheel cylinder 3, and a brake fluid resupply passage 10 having a solenoid valve 10a for resupplying brake fluid from the master cylinder 2 to the wheel cylinder 3, and a controller 11 for controlling the operation of these elements.

While not shown, the circulating passage 7 and the brake fluid resupply passage 10 are connected to all of the wheel cylinders 3. The pump 8 in the circulating passage 7 and the solenoid valve 10a in the brake fluid resupply passage 10 are commonly used for the wheel cylinders 3.

To the controller 11, an ignition switch 12 for starting the vehicle, a stepping force sensor la for the brake pedal 1, a pressure sensor 9 for the wheel cylinder 3, and the below-described alarm lamp 13 are connected. The controller 11 controls the actuation of the pump 8 and the solenoid valves 7a, 7b and 10a during travel of the vehicle based on the outputs of the stepping force sensor la and the pressure sensor 9, and also carries out the following control when the vehicle is started.

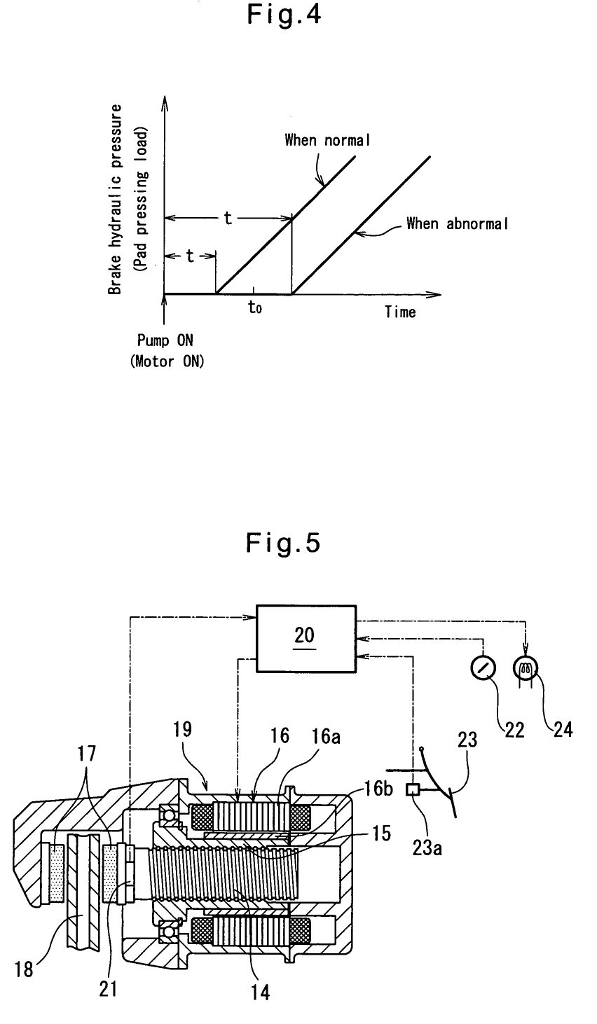

FIG. 3 shows a control flowchart of the controller 11 at the start of the vehicle. When the ignition switch 12 is closed, the controller 11 will close the solenoid valve 10a in the brake fluid resupply passage 10, drives the pump 8, compares the rise time t of brake hydraulic pressure with a preset threshold t0 from the output of the pressure sensor 9 shown in FIG. 4. If the rise time t is longer than the threshold t0, the controller 11 turns on the alarm lamp 13 to notify the driver of abnormality of the hydraulic brake device 6. Thus, the driver can know abnormality of the hydraulic brake device 6 before driving the vehicle, so that he can quickly deliver the vehicle for inspection or repair.

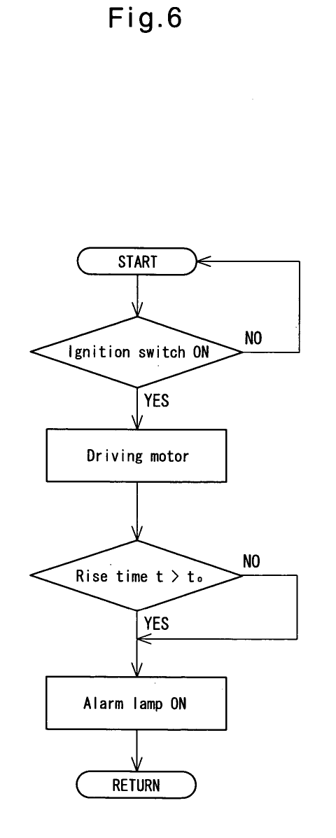

FIGS. 5 and 6 show the second embodiment. This vehicle braking device comprises a power brake device 19 and a controller 20 that controls its actuation. In the brake device 19, a nut 15 of a ball screw engages a piston 14 as a threaded shaft and is rotated by a motor 16 having an solenoid coil 16a and magnets 16b. The rotary motion of the nut 15 is converted to linear motion of the piston 14 to press the pads 17 against the disk rotor 18 by the linear motion of the piston 14. At the tip of the piston 14, a load sensor 21 for detecting the pressing load of the pads 17 is mounted.

To the controller 20, an ignition switch 22 for starting the vehicle, a stepping force sensor 23a for the brake pedal 23, the load sensor 21 of the piston 14, and an alarm lamp 24 are connected. The controller 20 controls the actuation of the motor of the power brake device 19 based on the outputs of the stepping force sensor 23a and the load sensor 21 during travel of the vehicle, and also carries out the following control when the vehicle is started. This is similar to the first embodiment.

FIG. 6 shows a control flowchart of the controller 20 at the start of the vehicle. When the ignition switch 22 is closed, the controller 20 activates the motor 16 of the power brake device 19, compares the rise time t of the load sensor 21, which is similar to the one shown in FIG. 4, with a preset threshold t0, and if the rise time t is longer than the threshold t0, turns on the alarm lamp 24 to notify the driver of abnormality of the hydraulic brake device 6. The control at the start of the vehicle can be carried out in the same manner for one having a fluid resupply type power brake device, too.

In the embodiments, as the alarm generating means for notifying abnormality of the brake device, an alarm lamp was used. But any other alarm generating means such as a buzzer may be used.

As described above, with the vehicle braking device of this invention, when the ignition switch for starting the vehicle is closed, the pump for generating brake hydraulic pressure for the hydraulic pressure brake device, and the motor for generating pad pressing loads for the power brake device are actuated, the rise times of the outputs of the brake hydraulic pressure detecting means and the pad pressing load detecting means provided in the hydraulic brake device and the power brake device, respectively, are detected, and an abnormality determining means is provided which determines that the brake device is abnormal if the rise times are later than a preset predetermined time. Thus, it is possible to detect abnormality of the brake device with a simple structure without providing a special detecting means.

By providing the alarm generating means for generating an alarm if the abnormality determining means determines that the brake device is abnormal, it is possible to notify the driver of abnormality of the brake device before he or she drives the vehicle, and thus to prompt the driver to earlier inspection or repair.

What is claimed is:

1. A vehicle braking device for a vehicle started by an ignition switch and comprising a master cylinder coupled to a brake pedal, a wheel cylinder, a hydraulic brake device for pressing pads against a disk rotor under brake hydraulic pressure of said wheel cylinder, a pump for supplying brake fluid from said master cylinder toward said wheel cylinder to generate brake hydraulic pressure in said wheel cylinder, and a brake hydraulic pressure detecting means for detecting the brake hydraulic pressure in said wheel cylinder, wherein said hydraulic brake device is controlled according to the operation of the brake pedal, wherein when said ignition switch is closed, said pump is driven and the rise time of the brake hydraulic pressure is detected by said brake hydraulic pressure detecting means, and further comprising an uneven wear detecting means which determines that uneven wear of the pads has occurred if the rise time of the brake hydraulic pressure is longer than a predetermined time.

2. A vehicle braking device as claimed in claim 1 further comprising a brake fluid resupply passage for resupplying brake fluid from said master cylinder to said wheel cylinder, wherein when said ignition switch is closed, said brake fluid resupply passage is shut off.

3. A vehicle braking device for a vehicle started by an ignition switch, comprising a power brake device for converting the rotary motion of a motor to the linear motion of a piston and pressing pads against a disk rotor with the linear motion of said piston, and a pad pressing load detecting means for detecting the pressing load of the pads against the disk rotor by said piston, wherein said power brake device is controlled according to the operation of the brake pedal, wherein when said ignition switch is closed, said motor is driven and the rise time of the pad pressing load is detected by said pad pressing load detecting means, and further comprising an uneven wear detecting means which determines that uneven wear of the pads has occurred if the rise time of the pad pressing load is longer than a predetermined time.

4. A vehicle braking device as claimed in claim 1 further comprising an alarm producing means for producing an alarm if said uneven wear detecting means determines that uneven wear of the pads has occurred.

5. A vehicle braking device as claimed in claim 3 further comprising an alarm producing means for producing an alarm if said uneven wear detecting means determines that uneven wear of the pads has occurred.
